(19) United States
(12) Patent Application Publication
(10) Pub. No.: US 2026/0022801 A1
(43) Pub. Date: Jan. 22, 2026

(54) SYSTEMS AND METHODS OF FIREFIGHTER AIR REPLENISHMENT SYSTEM PUMP AIR USAGE REDUCTION

(71) Applicant: Tyco Fire Products LP, Cranston, RI (US)

(72) Inventors: Jeremie LeClair, Foxborough, MA (US); James Leuzarder, Wakefield, RI (US)

(73) Assignee: Tyco Fire Products LP, Cranston, RI (US)

(21) Appl. No.: 19/266,556

(22) Filed: Jul. 11, 2025

Related U.S. Application Data
(60) Provisional application No. 63/671,856, filed on Jul. 16, 2024.

(51) Int. Cl. F17C 5/06; F17C 5/00

(52) U.S. Cl. CPC F17C 5/06; F17C 5/005

(57) ABSTRACT

An air replenishment system includes at least one air storage tank, a pump, a plurality of air fill stations, and a check valve. The at least one air storage tank has air at a storage pressure greater than or equal to 3000 psig. The pump is coupled with the at least one air storage tank. The pump is to receive the air from the at least one storage tank and output the air at a target pressure. The plurality of air fill stations is to receive the air from the pump. The check valve is to direct air from the at least one air storage tank to the plurality of air fill stations responsive to the storage pressure being greater than or equal to the target pressure.

### CROSS-REFERENCE TO RELATED APPLICATIONS

The present application claims the benefit of and priority to U.S. Provisional Application No. 63/671,856, filed Jul. 16, 2024, the disclosure of which is incorporated herein by reference in its entirety.

### BACKGROUND

A structure (e.g., a vertical building, a horizontal building, a tunnel, marine craft) can have a firefighter air replenishment system (FARS) implemented therein. The FARS can have an emergency air fill station to enable firefighters and/or emergency personnel access breathable air.

### SUMMARY

At least one aspect relates to an air replenishment system, such as a firefighter air replenishment system (FARS). The air replenishment system can include at least one air storage tank, a pump, a plurality of air fill stations, and a check valve. The at least one air storage tank has air at a storage pressure greater than or equal to 3000 psig. The pump is coupled with the at least one air storage tank. The pump is to receive the air from the at least one storage tank and output the air at a target pressure. The plurality of air fill stations is to receive the air from the pump. The check valve is to direct air from the at least one air storage tank to the plurality of air fill stations responsive to the storage pressure being greater than or equal to the target pressure.

At least one aspect relates to an air replenishment system, such as a FARS. The air replenishment system can include at least one air storage tank, a pump, a plurality of air fill stations, and a pressure regulator. The at least one air storage tank has air at a storage pressure greater than or equal to 3000 psig. The pump is coupled with the at least one air storage tank. The pump is to receive the air from the at least one storage tank and output the air at a target pressure. The plurality of air fill stations is to receive the air from the pump. The pressure regulator is to control a drive pressure of drive air provided to drive the pump, the drive pressure less than a nominal pressure rating of the pump.

At least one aspect relates to a system. The system can include a plurality of first air cylinders to provide air for use in a firefighting operation, a plurality of second air cylinders to store air at a storage pressure, at least one pump, a check valve, and a pressure regulator. The at least one pump is to pump air from the plurality of second air cylinders to the plurality of first air cylinder. The check valve is coupled with the plurality of first air cylinders and with the plurality of second air cylinders. The check valve is to allow air in the plurality of second air cylinders to flow to the plurality of first air cylinders responsive to the storage pressure being greater than or equal to a target pressure for the air in the plurality of first air cylinders. The pressure regulator is coupled with the at least one pump to provide drive air for the at least one pump to use to pump the air from the plurality of second air cylinders to the plurality of first air cylinders, the pressure regulator having a pressure setting less than 100 psig.

At least one aspect relates to a method. The method can include providing a pneumatic pump to pump air from a plurality of storage cylinders through a piping system to a plurality of air delivery cylinders. The method can include connecting a check valve with the plurality of storage cylinders and the plurality of air delivery cylinders. The method can include connecting a pressure regulator with the pump.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a schematic diagram of an example of a firefighter air replenishment system.

FIG. 2 is a schematic diagram of an example of a pump system of a firefighter air replenishment system.

FIG. 3 is a flow diagram of a method of deploying a pump system of a firefighter air replenishment system.

### DETAILED DESCRIPTION

Following below are more detailed descriptions of various concepts related to, and implementations of systems and methods of firefighter air replenishment systems (FARSs), such as a FARS that can implement a pump and/or pump system to allow for reduced air usage, such as for boosting of pressure of air from a storage pressure to an operating pressure. The various concepts introduced above and discussed in greater detail below can be implemented in any of numerous ways, including in standby operation of air pipes in buildings implementations.

FARSs can be used to provide air, such as pressurized air, at various locations in an environment, such as a building or other structure in which access to breathable air may be limited. The pressurized air can be delivered to one or more fill stations, such for a firefighter to retrieve the air, such as to refill air bottles or cylinders. For example, the pressurized air can be retrieved as breathable air at one or more access points, such as fill stations, such as during an incident (e.g., a fire, smoke/air pollution) occurring in the structure. The access points can be coupled with an air supply by a piping assembly that delivers the air to the access points from the air supply. The piping assembly can include or be coupled with any of various air storage tanks, pipes, valves. For example, the FARS can include a stand pipe for air to connect air supply elements (storage tanks, etc.) with access points. This can address logistical issues with making air available in complex structures, such as multi-story buildings or tunnels, for example.

The FARS can include or be coupled with one or more pumps (e.g., booster pumps, pneumatic booster pumps) to increase the pressure of air from the air supply from a pressure at which the air is stored to a pressure at which the air is to be used (e.g., 4500 pounds per square inch gauge pressure (psig) to 5500 psig, or higher). Some FARS use some of the stored air to drive the one or more pumps and/or compressors to drive the one or more pumps (which can also rely on air from the air supply). As such, FARS can require additional air and/or components (compressors, pumps, storage cylinders) and/or space (e.g., footprint for the components) to facilitate the air pressure boosting, and where such air is not used for output to a firefighter.

Systems and methods in accordance with the present disclosure can implement a FARS that can operate with reduced air usage while achieving operating pressure for the air to be delivered to the access points. This can include, for example, the use of one or more of a check valve to bypass at least a subset of pumps where the storage air meets or exceeds a supply pressure; lowering the inlet pressure of the drive air to the one or more pumps; a configuration of the one or more pumps to allow for lower volume ratio of the boosting performed; and/or dynamic variation of the air inlet pressure. Various such components and/or operating modes of the FARS can allow for the amount of air, e.g., drive air pressure to the pumps, to be reduced, and/or to allow for a greater proportion of available air to be used for firefighting, rather than for drive air pressure.

For example, a system (e.g., a FARS) can include a source of air, such as one or more air storage tanks. The source of air can have air at a relatively high operating pressure, such as an operating pressure greater than or equal to 3000 psig (e.g., 4000 to 6000 psig), and/or can be coupled with one or more pumps (e.g., booster pumps) to increase the pressure of air from a standby pressure to the operating pressure. The system can include a plurality of air fill stations. The system can include a piping assembly coupled with the source of air and with the plurality of air fill stations. The system can include a pump coupled with at least one air storage tank of the source of air. The pump can receive the air from the at least one storage tank and output the air at a target pressure. The plurality of air fill stations can receive the air from the pump. The system can include a check valve to direct air from the at least one air storage tank to the plurality of air fill stations responsive to the storage pressure being greater than or equal to the target pressure. The system can include a pressure regulator to set a pressure of drive air provided to the pump to drive the pumping operation of the pump. The check valve and/or the pressure regulator, for example, can facilitate selective delivery of air to downstream usage, reducing need for air to be used as drive air.

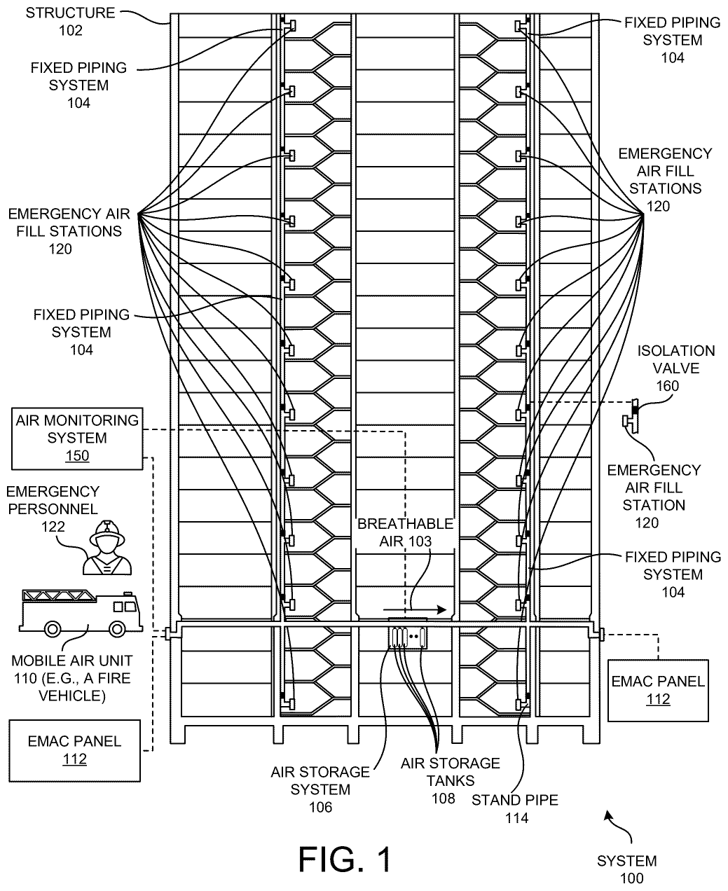

FIG. 1 depicts an example of a system 100, such as a safety system or FARS. The system 100 can enable firefighters entering a structure 102 in times of fire-related emergencies to gain access to breathable (e.g., human breathable) air (e.g., breathable air 103) in the structure, without the need of bringing in air bottles/cylinders to be transported up several flights of stairs of the structure 102 or deep into the structure 102, or to refill depleted air bottles/cylinders that are brought into the structure 102.

The structure 102 can include any of various vertical building structures, horizontal building structures (e.g., shopping malls, hypermarts, extended shopping, storage and/or warehousing related structures, data centers), tunnels, marine craft (e.g., large marine vessels such as cruise ships, cargo ships, submarines and large naval craft, which may be floating versions of buildings and horizontal structures) and mines.

The system 100 can supply breathable air provided from a supply of air tanks (described further herein) that can be stored in the structure 102 or coupled with air piping components located in the structure 102. For example, when a fire department vehicle arrives at the structure 102 during an emergency, breathable air supply can be provided through a source of air connected to the vehicle. The safety system 100 can enable firefighters to refill air bottles/cylinders at emergency air fill stations located at one or more locations in the structure 102.

For example, the system 100 can allow for firefighters to fill air bottles/cylinders at one or more access points (e.g., fill stations 120) in the structure 102 under full respiration in less than one to two minutes. The system 100 can include a piping system 104 (e.g., piping assembly), which can be permanently installed within structure 102 to provide the breathable air 103. The piping system 104 can include any of various pipes and/or pipe components (e.g., pipes, conduits, fittings, valves, joints) to direct air flow through the piping system 104.

As depicted in FIG. 1, the piping system 104 can distribute breathable air 103 across floors/levels of the structure 102. The piping system 104 can distribute breathable air 103 from an air storage system 106, which can be at least partially disposed in the structure 102. The air storage system 106 can include one or more air storage tanks 108 that serve as sources of pressurized/compressed air (e.g., breathable air 103).

The piping system 104 can connect with a mobile air unit 110 (e.g., a fire vehicle) through an External Mobile Air Connection (EMAC) panel 112. The EMAC panel 112 can be a boxed structure (e.g., exterior to the structure 102) to enable the connection between the mobile air unit 110 and the system 100. For example, the mobile air unit 110 can include an on-board air compressor, as well as piping, tanks, bottles, etc., to store and replenish pressurized/compressed air (e.g., breathable air analogous to breathable air 103) in air bottles/cylinders (e.g., utilizable with Self-Contained Breathing Apparatuses (SCBAs) carried by firefighters). Firefighters, for example, may be able to fill breathable air (e.g., breathable air 103, breathable air analogous to breathable air 103) into air bottles/cylinders (e.g., spare bottles, bottles requiring replenishment of breathable air) carried on the mobile air unit 110 through the system 100.

An air monitoring system 150 can be installed as part of the system 100 to automatically track and monitor a parameter (e.g., pressure) and/or a quality (e.g., indicated by moisture levels, carbon monoxide levels) of the breathable air 103 within the system 100. The air monitoring system 150 can be communicatively coupled with the air storage system 106 and the EMAC panel 112. The EMAC panel 112 can be at a remote location associated with (e.g., internal to, external to) the structure 102. To monitor the parameters and/or the quality of breathable air of the system 100, the air monitoring system 150 can include various sensors. For example, a pressure sensor of the air monitoring system 150 can automatically sense and record a pressure of the breathable air 103 of the system 100. The pressure sensor can communicate with an alarm system that is triggered responsive to the sensed pressure being outside a safety range. The air monitoring system 150 can automatically trigger a shutdown of breathable air distribution through the system 100 in case of impurity/contaminant (e.g., carbon monoxide) detection therethrough yielding levels above a safety/predetermined threshold.

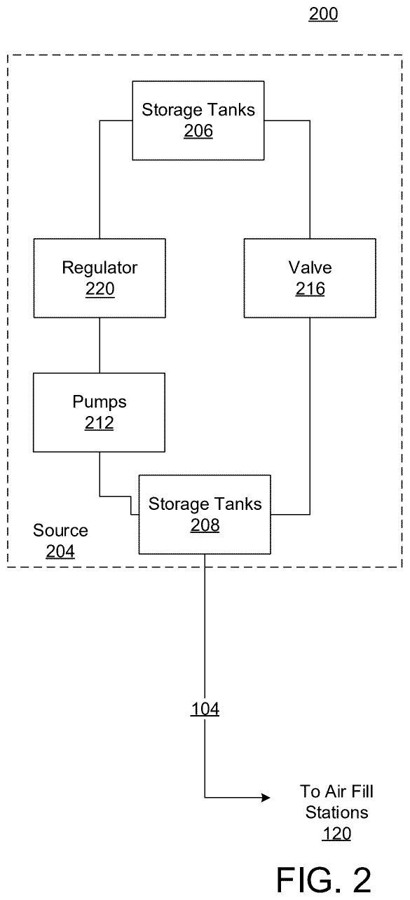

The piping system 104 can include one or more pipes (for example and without limitation, stainless steel tubing pipes) that distribute the breathable air 103 to one or more fill stations 120. The piping system 104 can include, for example, one or more stand pipes 114 (e.g., vertical pipes extending through the structure 102 to connect with fill stations 120 at multiple levels of the structure 102). The piping system 104 can include or be coupled with one or more pumps (e.g., pumps 212 described with reference to FIG. 2), such as booster pumps, to drive air through the piping system 104 to fill stations 120 (e.g., responsive to a pressure on a downstream side of the booster pumps falling below a target threshold, such as the operating pressure). The piping system 104 can include or be coupled with one or more flow control components, such as valves and/or pressure regulators, to control air flow and pressure of air flow through the piping system 104 to the air fill stations 120.

The fill stations 120 can be structures that function as access points to retrieve the breathable air 103. The fill stations 120 can be fill stations, such as emergency air fill stations. The fill station 120 can be a charge panel, an emergency air fill panel, or a rupture containment air fill station, for example.

As an example, each fill station 120 can be located at a specific level of the structure 102, such as to be each of a basement level, a first floor level, a second floor level and so on. The fill station 120 can be located at the end of the flight of stairs that emergency fighting personnel (e.g., firefighting personnel) climb to reach a specific floor level within the structure 102.

The fill station 120 can be a static location within a level of the structure 102 that provides emergency personnel 122 (e.g., firefighters, emergency responders) the ability to rapidly fill air bottles/cylinders (e.g., SCBA cylinders) with breathable air 103.

The system 100 can include one or more isolation valves 160. The isolation valves 160 can be proximate one or more respective fill stations 120. The isolation valves 160 can isolate a corresponding fill station 120 from a remaining portion of the system 100. For example, said isolation may be achieved through the manual turning of isolation valve 160 proximate the corresponding fill station 120, or the isolation valve 160 can be remotely actuated (e.g., based on automatic turning) from the air monitoring system 150. The air monitoring system 150 can maintain breathable air supply to a subset of the fill stations 120 via the piping system 104 through control of a corresponding subset of isolation valves 160.

FIG. 2 depicts an example of a system 200, such as an air supply system or pump system. The system 200 can be implemented as at least a portion of the system 100 to facilitate delivering air at operating pressure from the air storage system 106 to the fill stations 120. One or more components of the system 200 can be located in a same room or substructure of the structure 102 as the air storage system 106, which can facilitate ease of access to the system 200 to control the state of the system 200.

The system 200 can include or be coupled with at least one source 204 of air. The source 204 can include or be fluidly coupled with the one or more air storage tanks 108. As depicted in FIG. 2, the source 204 can include one or more first storage tanks 206 (e.g., storage cylinders), and can include one or more second storage tanks 208 (e.g., storage cylinders). The air in the source 204, such as in the one or more first storage tanks 206, can be stored at a relatively high pressure (e.g., above an operating pressure for the fill stations 120), such as 6000 psig.

The system 200 can include at least one pump 212. The pump 212 can be a booster pump, pneumatic pump, and/or compressor pump. The pump 212 can be coupled with the source 204, and can receive air from the source 204 and pump the air to downstream locations, such as through the piping system 104 and/or to fill stations 120. The pump 212 can increase a pressure of air from the source 204.

The pump 212 can be at least partially driven by the air from the source 204, such as to be powered by the pressure of air from the source 204 (e.g., to operate as a booster pump and/or bootstrapped booster pump). For example, the pump 212 can include or be coupled with an air splitter (e.g., valve, filter, tee joint) to separate at least a portion of the air from the source 204 between a first path for air to be outputted and a second path to drive one or more pump components (e.g., compressors, fans, impellers) of the pump 212 that compress the air on the first path. The pump 212 can output the air from the first path into the piping system 104, such as for delivery to fill stations 120. The amount of air used by the pump 212 on the second path can be relatively high, such as twice as much as the air delivered from the first path.

The pump 212 can be coupled with the first storage tanks 206 and/or second storage tanks 208. As depicted in FIG. 2, the pump 212 can be coupled with the first storage tanks 206 to pump air from the first storage tanks 206 to the second storage tanks 208, which can include increasing pressure of air from the first storage tanks 206 to a target pressure for the second storage tanks 208 and/or to the fill stations 120. The target pressure can be greater than or equal to 4000 psi and less than or equal to 6000 psi. The target pressure can be greater than or equal to 4500 psi and 5500 psi. The target pressure can be about equal to or greater than the operating pressure for the fill stations 120.

The system 200 can have a drive pressure of the pump 212, such as for drive air (e.g., from an air supply and/or building air supply at a location in which the pump 212 is provided, such as shop air) to be provided to the pump 212, at a threshold level sufficient to drive the pump. The threshold level can be based on an amount of pressure increase from the inlet pressure of air from the first storage tanks to the operating pressure. For example, some pumps used in FARSs are set to an inlet pressure associated with a nominal rating for the drive air, such as a nominal rating of 100 psig. This nominal rating can be higher than an amount of air needed to achieve the operating pressure, such as to boost the air from the first storage tanks 206 up to the operating pressure. The threshold level for the inlet pressure for the pump 212 can be based on at least one of the amount of pressure increase, a volume ratio of the pump 212, and a pump inertia factor. The pump inertia factor can indicate an amount of pressure and/or force to overcome inertia of the pump 212 and/or the components of the pump 212, such as to initiate movement of the pump 212 using the drive air. By setting the drive pressure of the pump 212 to the threshold level, the system 200 can use less air to operate the pump 212.

For example, the drive pressure can be based on Equation 1:

Drive pressure=(amount of pressure increase/volume ratio)+inertia factor Equation 1

As an example, the amount of pressure increase (e.g., maximum boost expected for a given system 200) can be 3000 psi, the volume ratio can be 60:1, the pump inertia factor can be 5 psig, and the drive pressure can be 55 psig. This can result in a forty five percent reduction of drive air used for each pumping cycle relative to operating the pump 212 at the nominal rating of 100 psig.

The system 200 can provide air from the first storage tanks 206 to drive the pump 212. This air (e.g., from the first storage tanks 206) can be at a relatively high pressure, e.g., a storage pressure of 3000 psig or greater. The pump 212 can have (e.g., be selected to have) a volume ratio that is relatively low (e.g., less than 60:1 as for the example above), such as to make the pump 212 more efficient and/or optimize the model of the pump 212 given the pressure of air available from the first storage tanks 206. This can allow the pump 212 to use less air to achieve the target pressure for the air to be pumped from the pump 212. For example, the pump 212 can be operated with a drive air pressure (e.g., using air from the first storage tanks 206) less than or equal to 150 psig, which can allow the volume ratio to be less than 60:1 (e.g., 30:1 for a target pressure of 4500 psig or greater). For example, the pump 212 can have a volume ratio greater than or equal to 3:1 and less than or equal to 45:1.

The system 200 can include at least one check valve 216. The check valve 216 can be coupled with the source 204, as well as the fill stations 120, e.g., downstream of the first storage tanks 206 and upstream of the fill stations 120. For example, the check valve 216 can be coupled with the first storage tanks 206 and the second storage tanks 208 between the first storage tanks 206 and the second storage tanks 208. The check valve 216 can be arranged to allow air flow from the first storage tanks 206 to the second storage tanks 208 and to prevent backflow from the second storage tanks 208 to the first storage tanks 206.

The check valve 216 can be used to reduce drive air consumption by the system 100, such as for operation of the pumps 212. For example, with pressure in the first storage tanks 206 being greater than pressure in the second storage tanks 208, the check valve 216 can allow air to flow (freely) from the first storage tanks 206 to the second storage tanks 208, such as to bypass the pumps 212. This can allow the second storage tanks 208 to have air at (or above) the target pressure where air in the first storage tanks 206 is at (or above) the target pressure, obviating the need for the pumps 212 to be driven with air from the first storage tanks 206 to bring the air in the second storage tanks 208 up to the target pressure. As such, the amount of air needed to be stored in the first storage tanks 206 can be reduced, such as to allow for fewer first storage tanks 206 to be used for a given system configuration, which can reduce footprint of the first storage tanks 206.

The system 200 can include at least one pressure regulator 220. The pressure regulator 220 can be coupled with the pump 212. For example, the pressure regulator 220 can be coupled with a drive air inlet of the pump 212 to provide drive air for operation of the pump 212 to the pump 212. The pressure regulator 220 can receive the drive air from at least one of an air supply (e.g., building air, shop air) and the first storage tanks 206. The pressure regulator 220 can be coupled with the first path from the first storage tanks 206 to the pump 212. The pressure regulator 220 can be used to control the pressure of the drive air provided to the pump 212. For example, the pressure regulator 220 can have a pressure setting set to the threshold level, such as to use air at a lower pressure than the nominal rating of the pump 212. The pressure regulator 220 can be a static pressure regulator.

The pressure regulator 220 can be a variable pressure regulator, such as an electronic variable pressure regulator. This can allow the pressure regulator 220 to provide dynamic variable drive air inlet pressure. For example, the pressure regulator 220 can be used to vary the inlet pressure of the drive air of the pump 212 to be a minimum sufficient to maintain pump operation, given the stall level of the pump 212 and the amount of pressure increase to be achieved using the pump 212. For example, the pressure regulator 220 can include or be coupled with a controller. The controller can include one or more processors coupled with memory. The controller can include any of various electronic control hardware devices, for example and without limitation, a microcontroller, an application specific integrated circuit (ASIC), or a field programmable gate array (FPGA). The processor may be a general purpose or specific purpose processor, an application specific integrated circuit (ASIC), a programmable logic controller (PLC), one or more field programmable gate arrays (FPGAs), a group of processing components, or other suitable processing components. The processor may be configured to execute computer code or instructions stored in memory (e.g., fuzzy logic, etc.) or received from other computer readable media (e.g., CDROM, network storage, a remote server, etc.) to perform one or more of the processes described herein. The memory may include one or more data storage devices (e.g., memory units, memory devices, computer-readable storage media, etc.) configured to store data, computer code, executable instructions, or other forms of computer-readable information. The memory may include random access memory (RAM), read-only memory (ROM), hard drive storage, temporary storage, non-volatile memory, flash memory, optical memory, or any other suitable memory for storing software objects and/or computer instructions. The processor can be implemented as a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof. The memory may include database components, object code components, script components, or any other type of information structure for supporting the various activities and information structures described in the present disclosure. The memory may be communicably connected to the processor via the controller and may include computer code for executing (e.g., by processor) one or more of the processes described herein. The memory can include various modules (e.g., circuits, engines) for completing processes described herein. For example, the controller (e.g., in memory for execution by the one or more processors) can include one or more functions, equations of state, state functions, rules, heuristics, models (e.g., machine learning models, physics models, chemistry models), regression, calibrations, algorithms, or various combinations thereof, to determine the drive pressure, such as based on inputs received from one or more pressure sensors. The controller can include one or more input and/or output ports for electronic communication with various components of the system 200.

For example, the pressure regulator 220 (and/or controller) can determine and/or set the drive pressure based at least on the amount of pressure increase, the volume ratio of the pump 212, and the pump inertia factor. For the pressure regulator 220, the amount of pressure increase can be real-time and/or dynamic value, such as a current amount of boost to be provided, rather than a static value, such as a maximum value of boost expected to be needed; this can allow the system 200 to use drive air more efficiently than by relying on the nominal rating of the pump 212. For example, the pressure regulator 220 can determine the drive pressure based on Equation 2:

Drive pressure=(current pressure increase/volume ratio)+inertia factor Equation 2

The pressure regulator 220 can determine the current amount of pressure increase based on the target pressure and the pressure of air from the first storage tanks 206. As an example, based on a current amount of pressure increase of 600 psi, a volume ratio of 60:1, and a pump inertia factor of 5 psig, the pressure regulator 220 can set the drive pressure to 15 psig (e.g., as compared to a nominal pressure rating of 100 psig).

The system 200 can include, for example, the check valve 216 and the pressure regulator 220. It can be useful to include each of the check valve 216 and pressure regulator 220 (or one of the check valve 216 or pressure regulator 220) based on factors such as the source of air to be used for the pumps 212 and the pressure of air in the first storage tanks 206. It can be useful to include the volume ratio selection for the pump 212 with one or more of the check valve 216 and/or pressure regulator 220, such as to facilitate reduced drive air usage.

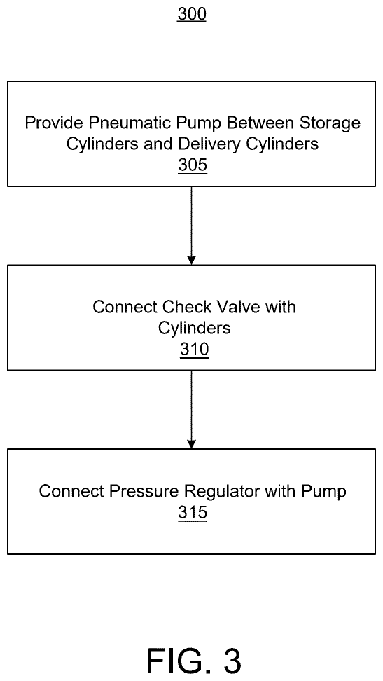

FIG. 3 depicts an example of a method 300 of providing a FARS. The method 300 can be performed, for example, during installation and/or retrofitting or updating of the FARS. The method 300 can be performed to allow for reduced air usage by the FARS, such as relative to FARSs that are deployed using pumps for pumping air to primary cylinders (e.g., delivery cylinders) at high nominal drive pressures, such as drive pressures of 100 psig or higher.

At 305, a pump can be provided to pump air from a plurality of storage cylinders through a piping system to a plurality of delivery cylinders (e.g., primary cylinders). The pump can be a pneumatic pump, such as a pump that receives drive air on a separate path from the air to be pumped, and is driven by the received drive air. The pump can have a nominal rating for pressure of the drive air to be used to perform pumping; for example, the nominal rating can be about 100 psig.

At 310, a valve can be connected with the plurality of storage cylinders and the plurality of delivery cylinders. The valve can be a check valve. For example, the valve can be arranged to allow for air flow from the storage cylinders to the delivery cylinders, e.g., responsive to air pressure in the storage cylinders being greater than in the delivery cylinders, and can be arranged to prevent backflow from the delivery cylinders to the storage cylinders. The check valve can be positioned on a separate flow path between the storage cylinders and the delivery cylinders than a flow path on which the pump is positioned, such as to allow the air to flow through the check valve while bypassing the pump.

At 315, a pressure regulator can be connected with the pump. The pressure regulator can have a pressure setting to control a pressure of the drive air provided to the pump. For example, the pressure regulator can be connected with a source of the drive air and an inlet of the pump for the drive air, where the source can include at least one of the storage cylinders and an air supply separate from the storage cylinders. The pressure regulator can be a static pressure regulator, such as to maintain the pressure setting at a static value, which can be less than the nominal pressure rating of the pump. The pressure regulator can be a variable pressure regulator, such as to dynamically modify the pressure setting to achieve a target increase in pressure for the air outputted by the pump.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

What is claimed is:

1. An air replenishment system, comprising:
at least one air storage tank having air at a storage pressure greater than or equal to 3000 psig;
a pump coupled with the at least one air storage tank, the pump to receive the air from the at least one storage tank and output the air at a target pressure;
a plurality of air fill stations to receive the air from the pump; and
a check valve to direct air from the at least one air storage tank to the plurality of air fill stations responsive to the storage pressure being greater than or equal to the target pressure.

2. The air replenishment system of claim 1, comprising:
the pump comprises a pneumatic pump to use air from the at least one air storage tank or from an air supply to pump the air from the at least one storage tank to the plurality of air fill stations.

3. The air replenishment system of claim 1, comprising:
the at least one air storage tank comprises a plurality of first air cylinders; and
the plurality of air fill stations comprise a plurality of second air cylinders.

4. The air replenishment system of claim 1, comprising:
the check valve is positioned to bypass the pump to direct the air from the at least one air storage tank to the plurality of air fill stations responsive to the storage pressure being greater than or equal to the target pressure, and to prevent backflow of air from the plurality of air fill stations to the at least one air storage tank.

5. The air replenishment system of claim 1, comprising:
the pump is to pump air from the at least one air storage tank to the plurality of air fill stations using drive air at a pressure less than 100 psig.

6. The air replenishment system of claim 1, comprising:
the pump has a volume ratio less than or equal to 45:1.

7. The air replenishment system of claim 1, comprising:
one or more first pipes couple the at least one air storage tank with the pump; and
one or more second pipes couple the at least one air storage tank with the check valve.

8. The air replenishment system of claim 1, comprising:
a pressure regulator to control a drive pressure of drive air provided to drive the pump.

9. The air replenishment system of claim 1, comprising:
the target pressure is greater than or equal to 4500 psig.

10. An air replenishment system, comprising:
at least one air storage tank having air at a storage pressure greater than or equal to 3000 psig;
a pump coupled with the at least one air storage tank, the pump to receive the air from the at least one storage tank and output the air at a target pressure;
a plurality of air fill stations to receive the air from the pump; and
a pressure regulator to control a drive pressure of drive air provided to drive the pump, the drive pressure less than a nominal pressure rating of the pump.

11. The air replenishment system of claim 10, comprising:
the pressure regulator is a static regulator having a pressure setting at the drive pressure.

12. The air replenishment system of claim 10, comprising:
the drive pressure is based on at least one of an amount of pressure increase to be performed by the pump, a volume ratio of the pump, and a pump inertia factor.

13. The air replenishment system of claim 10, comprising:
the pressure regulator is to determine the drive pressure based on an inlet pressure of the air from the at least one storage tank, the target pressure, the volume ratio, and a pump inertia factor.

14. The air replenishment system of claim 10, comprising:
the pump has a volume ratio less than or equal to 45:1.

15. The air replenishment system of claim 10, comprising:
the drive pressure is less than 100 psig.

16. The air replenishment system of claim 10, comprising:
the pressure regulator is coupled by one or more first pipes with the at least one air storage tank and the pump; and
a check valve is coupled by one or more second pipes with the at least one air storage tank and the plurality of air fill stations, the check valve positioned to allow for air flow to bypass the pump responsive to the storage pressure being greater than the target pressure.

17. The air replenishment system of claim 10, comprising:
the pressure regulator is to receive, from a pressure sensor, an inlet pressure of the air, and is to determine the drive pressure based on the inlet pressure.

18. A system, comprising:
a plurality of first air cylinders to provide air for use in a firefighting operation;
a plurality of second air cylinders to store air at a storage pressure;
at least one pump to pump air from the plurality of second air cylinders to the plurality of first air cylinders;
a check valve coupled with the plurality of first air cylinders and with the plurality of second air cylinders, the check valve to allow air in the plurality of second air cylinders to flow to the plurality of first air cylinders responsive to the storage pressure being greater than or equal to a target pressure for the air in the plurality of first air cylinders; and
a pressure regulator coupled with the at least one pump to provide drive air for the at least one pump to use to pump the air from the plurality of second air cylinders to the plurality of first air cylinders, the pressure regulator having a pressure setting less than 100 psig.

19. The system of claim 18, comprising:
the pressure regulator is to determine the drive pressure based on an inlet pressure of the air from the plurality of second air cylinders, the target pressure, a volume ratio of the at least one pump, and an inertia factor of the at least one pump.

20. The system of claim 18, comprising:
the at least one pump has a volume ratio less than or equal to 45:1.
